(19) United States
(12) Patent Application Publication
(10) Pub. No.: US 2026/0017930 A1
(43) Pub. Date: Jan. 15, 2026

(54) METHOD, DEVICE, AND MEDIUM FOR TRAINING LARGE SCALE OBJECT FOUNDATION MODEL

(71) Applicant: Lemon Inc., Grand Cayman (KY)

(72) Inventors: Song BAI, Singapore (SG); Junfeng WU, Beijing (CN)

(21) Appl. No.: 18/768,342

(22) Filed: Jul. 10, 2024

(51) Int. Cl. G06V 10/774; G06T 7/20; G06V 10/80; G06V 20/70

(52) U.S. Cl. CPC G06V 10/774; G06T 7/20; G06V 10/806; G06V 20/70; G06T 2207/10016; G06T 2207/20081

(57) ABSTRACT

Embodiments of the present disclosure provide a method, device, and medium for training a large scale object foundation model. The method comprises obtaining a training dataset comprising a plurality of subsets for a plurality of object perception tasks, wherein a sample in the training dataset comprises an image with an object, a prompt indicating the object, and labeled object perception information of the image. The method further comprises generating, by the image encoder, an image feature based on the image. The method further comprises generating, by the text encoder or the visual prompt encoder, a prompt embedding based on the prompt. The method further comprises generating, by the object decoder, object perception information of the object based on the image feature and the prompt embedding. In addition, the method further comprises training the object processing model based on the generated object perception information and the labeled object perception information.

### BACKGROUND

In the field of computer vision, object perception tasks are fundamental for enabling machines to understand and interact with their environment. The object perception tasks comprise object detection, object segmentation, object tracking, etc. Each of these tasks focuses on different aspects of locating and identifying objects within images or videos.

The object detection task involves determining what objects are present and where they are located. Objects may be enclosed within rectangular boxes, indicating their position and size. In some object detection tasks, in addition to the bounding box, each detected object may be assigned a category label, for example, person, car, dogs, etc. The object segmentation task is not only to detect objects, but also to depict the precise boundaries of objects in the image. In the object segmentation task, masks may delineate the boundaries of objects within an image, effectively providing a detailed map of where objects are located and what their shapes are. The object tracking task focuses on following the movement of objects across multiple frames in a video. It aims to maintain the identity of objects as they move through the scene. Some object tracking tasks may track one object at a time throughout the video, and some object tacking tasks may track multiple objects simultaneously, maintaining their identities over time.

### SUMMARY

In a first aspect according to some embodiments of the present disclosure, a method for training an object processing model is provided. The object processing model comprises an image encoder, a text encoder, a visual prompt encoder and an object decoder, and the method comprises obtaining a training dataset comprising a plurality of subsets for a plurality of object perception tasks, wherein a sample in the training dataset comprises an image with an object, a prompt indicating the object, and labeled object perception information of the image. The method further comprises generating, by the image encoder, an image feature based on the image. The method further comprises generating, by the text encoder or the visual prompt encoder, a prompt embedding based on the prompt. The method further comprises generating, by the object decoder, object perception information of the object based on the image feature and the prompt embedding. In addition, the method further comprises training the object processing model based on the generated object perception information and the labeled object perception information.

In a second aspect according to some embodiments of the present disclosure, an electronic device comprising a memory and a processor is provided. The memory is configured to store computer instructions which, when executed by the processor, cause the processor to obtain a training dataset comprising a plurality of subsets for a plurality of object perception tasks, wherein a sample in the training dataset comprises an image with an object, a prompt indicating the object, and labeled object perception information of the image. The instructions further causes the processor to generate, by an image encoder, an image feature based on the image. The instructions further causes the processor to generate, by a text encoder or the visual prompt encoder, a prompt embedding based on the prompt. The instructions further causes the processor to generate, by an object decoder, object perception information of the object based on the image feature and the prompt embedding. In addition, the instructions further causes the processor to train an object processing model based on the generated object perception information and the labeled object perception information.

In a third aspect according to some embodiments of the present disclosure, a non-transitory computer-readable medium is provided. The medium comprises instructions stored thereon which, when executed by a processor, cause the processor to obtain a training dataset comprising a plurality of subsets for a plurality of object perception tasks, wherein a sample in the training dataset comprises an image with an object, a prompt indicating the object, and labeled object perception information of the image. The instructions further causes the processor to generate, by an image encoder, an image feature based on the image. The instructions further causes the processor to generate, by a text encoder or the visual prompt encoder, a prompt embedding based on the prompt. The instructions further causes the processor to generate, by an object decoder, object perception information of the object based on the image feature and the prompt embedding. In addition, the instructions further causes the processor to train an object processing model based on the generated object perception information and the labeled object perception information.

Any of the one or more above aspects in combination with any other of the one or more aspects. Any of the one or more aspects as described herein. This Summary is provided to introduce a selection of concepts in a simplified form, which is further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTION OF THE DRAWINGS

Embodiments of the present disclosure may be understood from the following Detailed Description when read with the accompanying figures. In accordance with the standard practice in the industry, various features are not drawn to scale. In fact, the dimensions of the various features may be arbitrarily increased or reduced for clarity of discussion. Some examples of the present disclosure are described with reference to the following figures.

FIG. 1 illustrates an example environment in which example embodiments of the present disclosure may be implemented;

FIG. 2 is a flow chart illustrating an example process of training an object processing model according to some embodiments of the present disclosure;

FIG. 3 is a schematic diagram illustrating an example training dataset used for training the object processing model according to some embodiments of the present disclosure;

FIG. 4A-4G are schematic diagrams illustrating annotations of different granularities from multiple subsets in the training dataset according to some embodiments of the present disclosure;

FIG. 5 is a schematic diagram illustrating an example architecture of the object processing model according to some embodiments of the present disclosure;

FIG. 6A-6E are schematic diagrams illustrating the execution of multiple object perception tasks using the trained object processing module during the inference stage according to some embodiments of the present disclosure; and

FIG. 7 is a block diagram illustrating physical components (for example hardware) of an electronic device with which aspects of the present disclosure may be practiced.

### DETAILED DESCRIPTION

In the following detailed description, references are made to the accompanying drawings that form a part hereof, and in which are shown by way of illustrations specific aspects or examples. These aspects may be combined, other aspects may be utilized, and structural changes may be made without departing from the present disclosure. Aspects may be practiced as methods, systems or devices. Accordingly, aspects may take the form of a hardware implementation, an entirely software implementation, or an implementation combining software and hardware aspects. The following detailed description is therefore not to be taken in a limiting sense, and the scope of the present disclosure is defined by the appended claims and their equivalents.

Foundation models are a new approach to building Artificial General Intelligence (AGI) systems, trained on extensive data and adaptable to various downstream tasks. While they have seen great success in Natural Language Processing (NLP), their application in computer vision is gaining interest. Unlike NLP tasks unified under a text-to-text paradigm, computer vision tasks vary significantly in form and definition, often leading to single-task learning frameworks that limit their applicability. Multi-modal visual foundation models show promise in transfer learning and zero-shot capabilities, but typically only learn image-level features, which are not directly applicable to object-level tasks.

Unified models aim to handle multiple vision or multi-modal tasks within a single model, similar to foundation models. They train across various vision tasks, solving them simultaneously and showing promising cross-task generalization. However, they often focus on image-level understanding and have slower inference speeds compared to state-of-the-art task-specific models. Some utilize unified maximum likelihood estimation and object retrieval for localization, but lack zero-shot generalization capabilities due to being trained on closed-set data.

Open-vocabulary detection and grounding models require the localization and recognition of many objects. Recent advancements in vision language pre-training have led to strategies for open-vocabulary detection that transfer knowledge from pre-trained vision-language models to object detectors and leverage large image-text datasets. However, these models are limited by the capabilities and biases of language models, making it difficult to excel in both localization and recognition simultaneously.

Therefore, the embodiments of the present disclosure provide a scheme for training an object processing model. The object processing model comprises an image encoder, a text encoder, a visual prompt encoder and an object decoder, and the scheme comprises obtaining a training dataset comprising a plurality of subsets for a plurality of object perception tasks, wherein a sample in the training dataset comprises an image with an object, a prompt indicating the object, and labeled object perception information of the image. The scheme further comprises generating, by the image encoder, an image feature based on the image. The method further comprises generating, by the text encoder or the visual prompt encoder, a prompt embedding based on the prompt. The scheme further comprises generating, by the object decoder, object perception information of the object based on the image feature and the prompt embedding. In addition, the scheme further comprises training the object processing model based on the generated object perception information and the labeled object perception information.

In this way, the trained object processing model can solve a broad range of object perception tasks simultaneously. By utilizing a unified input and output paradigm, the model is able to learn from diverse datasets and predict general object representations, allowing it to effectively generalize to new data and tasks in a zero-shot manner. Furthermore, the training data can be significantly expanded at a low cost by incorporating a large volume of automatically labeled data, which further enhances the zero-shot generalization capabilities of the model.

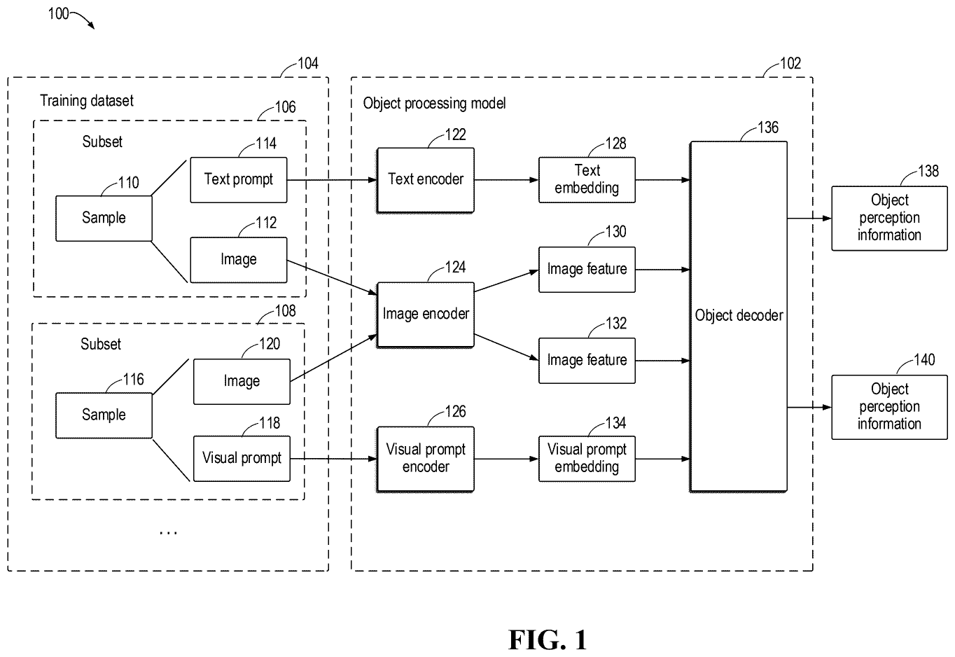

FIG. 1 illustrates an example environment 100 in which example embodiments of the present disclosure may be implemented. As shown in FIG. 1, the environment 100 comprises an object processing model 102 and a training dataset 104. The object processing model 102 comprises a text encoder 122, an image encoder 124, a visual prompt encoder 126 and an object decoder 136. The text encoder 122 may process arbitrary text descriptions related to various object perception tasks, including object categories, object names in any form, captions for objects (e.g., a dog playing with a ball in the park) and referring expressions (e.g., the dog chasing the red ball). The object categories refer to general names for objects in images or videos. Examples may comprise person, car, dog, cat, etc. The object names refer to specific names of objects, used for identifying particular objects. Examples may comprise bollards, manhole cover, etc. The captions for objects provide an overall description of the scene in an image or video, for example, including the activities or states of the objects, used for understanding context and scenes. Examples may comprise “a dog playing with a ball in the park”, “a red car parked by the side of the road”, etc. The referring expression provide detailed references to specific objects, used for distinguishing and locating objects. Examples may comprise “the dog chasing the red ball”, “the car parked next to the tree”.

The visual prompt encoder 126 may encodes a visual prompt such as points, bounding boxes, or scribbles during interactive segmentation into corresponding visual representations of target objects. A point may be a single pixel location for indicating the presence of an object, and may be used to mark a key location on the object of interest. A bounding box may be rectangular areas drawn around the object to indicate its general location and extent. A scribble may be a free-form line indicating a region of the object.

The image encoder 124 may be an image backbone network for extracting multi-scale image features from the input images. The image encoder 124 may convert the raw image into a multi-scale feature map. The multi-scale feature map may capture information in different levels, from low-level details such as edges and textures to high-level semantic information.

The object decoder 136 may transform the integrated feature representations into concrete object predictions. By leveraging attention mechanisms and specialized prediction heads, the object decoder 136 may ensure accurate detection, localization and classification of objects within the image.

The training dataset 104 may be used for training the object processing model 102. The training dataset 104 is critical for the ability of the model to generalize across various object perception tasks. The training dataset 104 may provide a diverse set of images or video frames and annotations that help the object processing model 102 to learn recognizing and delineating objects in various contexts and environments.

As shown in FIG. 1, the training dataset 104 may comprise multiple subsets for various object perception tasks. In the environment 100, the training dataset 104 may comprise a subset 106, a subset 108 and others. The subset 106 may comprise a sample 110, and the sample 110 may comprise an image 112 and a text prompt 114. For example, the subset 106, for example, may be a dataset for the object detection task. The text prompt 114 may be a list of categories, an arbitrary name, an object caption or a referring expression. The subset 108 may comprise a sample 116, and the sample 116 may comprise an image 120 and a visual prompt 118. The visual prompt 118 may be a point, a box or a scribble indicating an object in the image 120.

As shown in FIG. 1, the sample 110 may be fed into the object processing model 102. Then the object processing model 102 may generate object perception information 138 based on the image 112 and the text prompt 114. The object perception information 138 may be a bounding box or a mask of the object in the image 112 indicated by the text prompt 114. Furthermore, the sample 116 may also be fed into the object processing model 102. Then the object processing model 102 may generate object perception information 140 based on the image 120 and the visual prompt 118. The object perception information 140 may be a bounding box or a mask of the object in the image 120 indicated by the visual prompt 118.

In the environment 100, the image 112 may be fed into the image encoder 124. The image encoder 124 may extract an image feature 130 from the image 112. Furthermore, the text prompt 114 may be fed into the text encoder 122. The text encoder 122 may generate a text embedding 128 based on the text prompt 114. Then the image feature 130 and the text embedding 128 may be fed into the object decoder 136 to generate the object perception information 138. In the subset 106, the sample 110 may also comprise labeled object perception information. Therefore, the object processing model 102 may be trained based on the difference between the generated object perception information 138 and the labeled object perception information of the sample 110.

In addition, the image 120 may also be fed into the image encoder 124. The image encoder 124 may extract an image feature 132 from the image 120. Furthermore, the visual prompt 118 may be fed into the visual prompt encoder 126. The visual prompt encoder 126 may generate a visual prompt embedding 134 based on the visual prompt 118. Then the image feature 132 and the visual prompt embedding 134 may be fed into the object decoder 136 to generate the object perception information 140. In the subset 108, the sample 116 may also comprise labeled object perception information. Therefore, the object processing model 102 may also be trained based on the difference between the generated object perception information 140 and the labeled object perception information of the sample 116.

In this way, the object processing model 102 can solve a broad range of object perception tasks simultaneously. By utilizing a unified input and output paradigm, the object processing model 102 is able to learn from the multiple subsets (e.g., the subsets 106, 108 and others) in the training dataset 104 and predict general object representations, allowing it to effectively generalize to new data and tasks in a zero-shot manner. Furthermore, the training dataset 104 can be significantly expanded at a low cost by incorporating a large volume of automatically labeled data, which further enhances the zero-shot generalization capabilities of the object processing model 102.

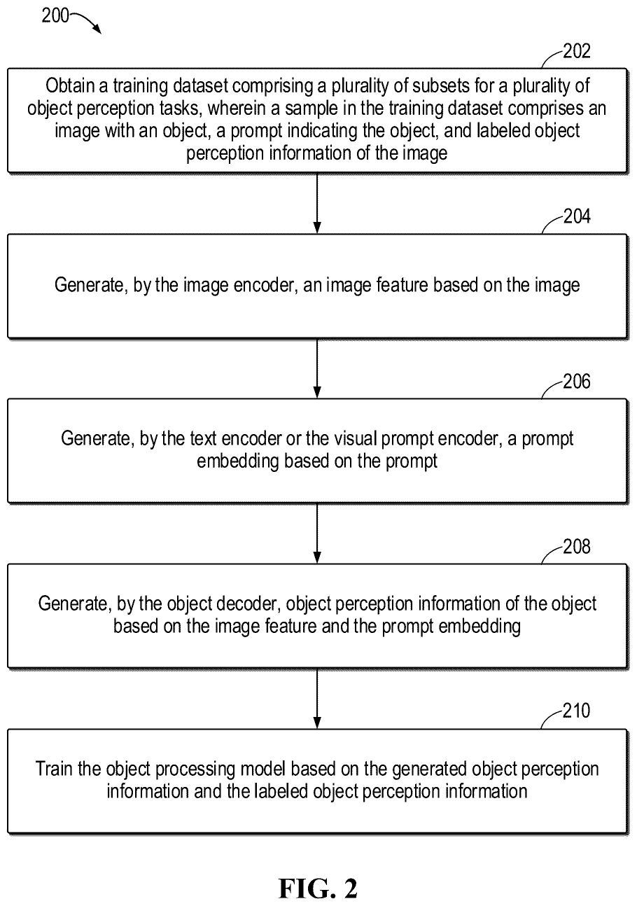

FIG. 2 is a flow chart illustrating an example method 200 of training an object processing model according to some embodiments of the present disclosure. The method 200 may be implemented by a processing unit. As shown in FIG. 2, at block 202, the processing unit may obtain a training dataset comprising a plurality of subsets for a plurality of object perception tasks, where a sample in the training dataset comprises an image with an object, a prompt indicating the object, and labeled object perception information of the image. For example, in the environment 100 as shown in FIG. 1, the training dataset 104 may be obtained, where the training dataset 104 may comprise subsets 106, 108 and others. The subsets 106 and 108 may be used for different object perception tasks. For example, the subset 106 may be used for an object detection task based on categories, and the subset 108 may be used for an instance segmentation task based on scribbles. The sample 110 may comprise the image 112 with an object, a text prompt 114 indicating the object, and labeled object perception information of the image 112. The sample 116 may comprise the image 120 with an object, a visual prompt 118 indicating the object, and labeled object perception information of the image 120. The training data set may be used for training the object processing model, where the object processing model may comprise an image encoder, a text encoder, a visual prompt encoder and an object decoder.

At block 204, the image encoder may generate an image feature based on the image. For example, in the environment 100 as shown in FIG. 1, the image 112 may be fed into the image encoder 124. The image encoder 124 may generate the image feature 130 based on the image 112.

At block 206, the text encoder or the visual prompt encoder may generate a prompt embedding based on the prompt. For example, in the environment 100 as shown in FIG. 1, when a prompt, for example the text prompt 114, is a text, the prompt may be fed into the text encoder 122. The text encoder may generate the text embedding 128 based on the text prompt 114. When a prompt, for example the visual prompt 118, is visual information, the prompt may be fed into the visual prompt encoder 126. The visual prompt encoder 126 may generate the visual prompt embedding 134 based on the visual prompt 118.

At block 208, the object decoder may generate object perception information of the object based on the image feature and the prompt embedding. For example, in the environment 100 as shown in FIG. 1, the image feature 130 and the text embedding 128 may be fed into the object decoder 136. The object decoder 136 may generate the object perception information 138 based on the image feature 130 and the text embedding 128.

At block 210, the processing unit may train the object processing model based on the generated object perception information and the labeled object perception information. For example, in the environment 100 as shown in FIG. 1, the object processing model 102 may be trained based on the generated object perception information 138 and the labeled object perception information of the image 112. For example, a loss may be determined based on the generated object perception information 138 and the labeled object perception information of the image 112. Therefore, the image encoder 124, the text encoder 122, the visual prompt encoder 126 and the object decoder 136 may be trained jointly based on the loss.

In this way, the trained object processing model can solve a broad range of object perception tasks simultaneously. By utilizing a unified input and output paradigm, the model is able to learn from diverse datasets and predict general object representations, allowing it to effectively generalize to new data and tasks in a zero-shot manner. Furthermore, the training data can be significantly expanded at a low cost by incorporating a large volume of automatically labeled data, which further enhances the zero-shot generalization capabilities of the model.

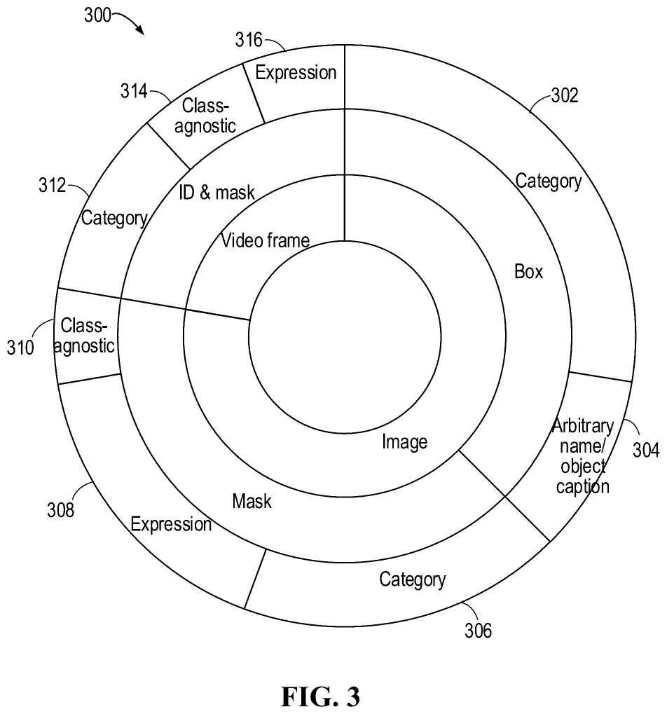

FIG. 3 is a schematic diagram illustrating an example training dataset 300 used for training the object processing model according to some embodiments of the present disclosure. Existing datasets differ in annotation granularity. For example, some detection datasets such as Objects365 and Open Images offer bounding boxes and category names. Furthermore, some detection datasets (e.g., COCO and LVIS) provide finer-grained mask annotations. In addition, some detection datasets (e.g., RefCOCO and Visual Genome) provide detailed object descriptions. The design of the unified framework, capable of addressing multiple tasks, enables joint training on over five million images from diverse benchmarks and varying levels of supervision.

As shown in FIG. 3, the training dataset 300 comprises multiple subsets with various types of data that are incorporated into the training process to ensure the robustness and generalization of the object processing model across different tasks. The first ring (i.e., the inner ring) indicates the types of input data, comprising images and video frames. Both of the images and the video frames may be used for training the object detection task and instance segmentation task. Furthermore, the video frames are also crucial for tasks such as video instance segmentation and object tracking where temporal information is important.

The second ring indicates the types of annotations, comprising bounding boxes, masks, and identification and masks. The bounding boxes are rectangular annotations around objects in the images or video frames, and they are fundamental for object detection tasks. The masks represents pixel-level annotations that delineate the exact shape of objects, and they are used for instance segmentation tasks. The combination of identification and masks may be used in video segmentation tasks to track objects over time while maintaining their identity.

The third ring indicates the types of prompts, comprising categories, arbitrary names or object captions, expressions and class-agnostic. The class-agnostic refers to data labeled without specific categories, focusing instead on distinguishing objects from the background or other objects, may be used in generic segmentation tasks.

As shown in FIG. 3, a subset 302 may comprise images, bounding boxes as annotations, and categories as prompts. For example, the subset 302 may be Open Images dataset. A subset 304 may comprise images, bounding boxes as annotations, and arbitrary names or object captions as prompts. For example, the subset 304 may be Visual Genome dataset. A subset 306 may comprise images, masks as annotations, and categories as prompts. For example, the subset 306 may be COCO dataset, LVIS dataset, or BDD dataset. A subset 308 may comprise images, masks as annotations, and expressions as prompts. For example, the subset 308 may be RefCOCO dataset. A subset 310 may comprise images and masks as annotations, and it is class-agnostic. A subset 312 may comprise video frames, identification and masks as annotations, and categories as prompts. For example, the subset 312 may be YTVIS19/21 data set and OVIS dataset. A subset 314 may comprise video frames, identification and masks as annotations, and it is class-agnostic. For example, the subset 314 may be UVO dataset. A subset 316 may comprise video frames, identification and masks as annotations, and expressions as prompts.

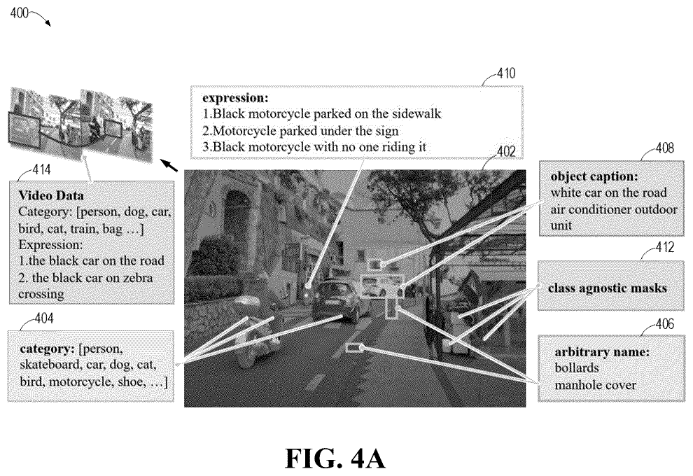

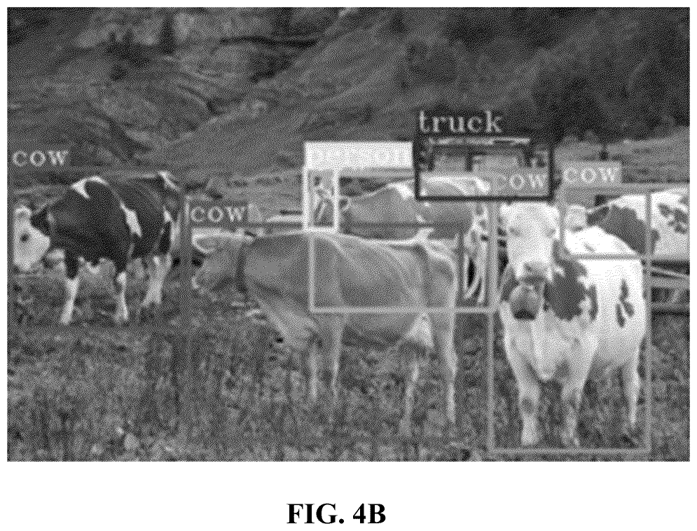

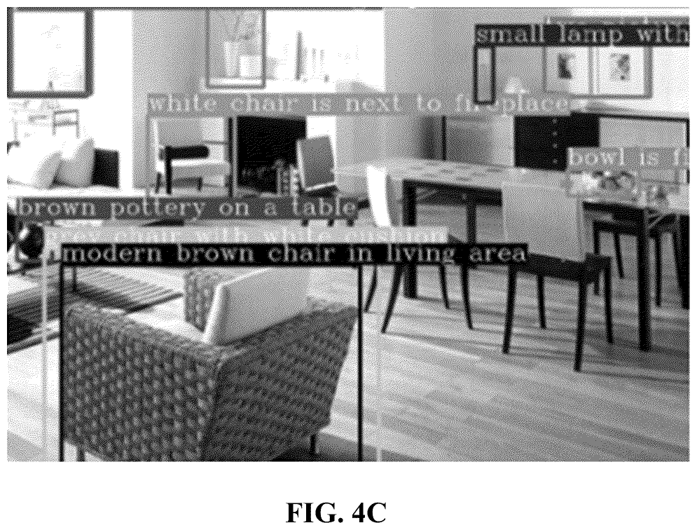

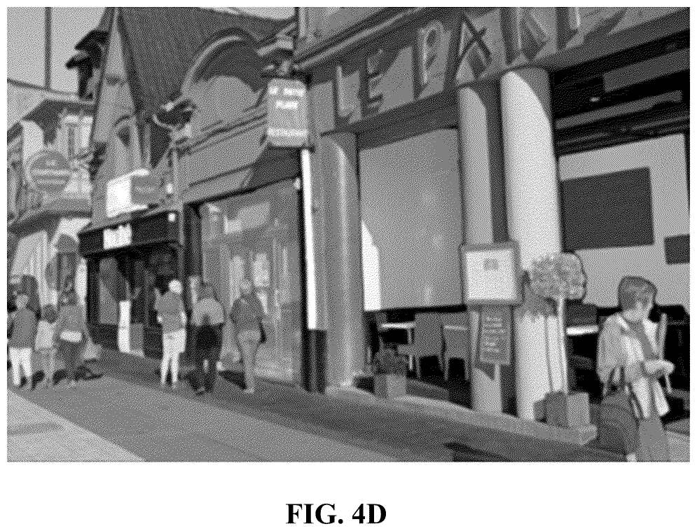

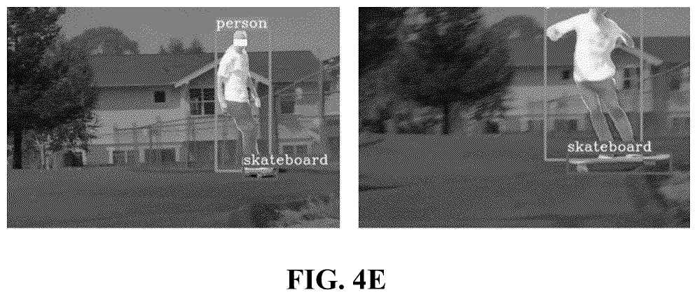

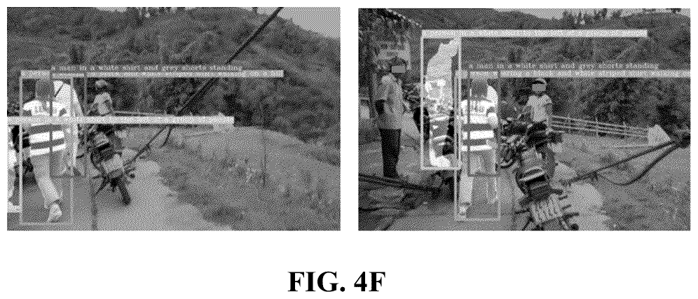

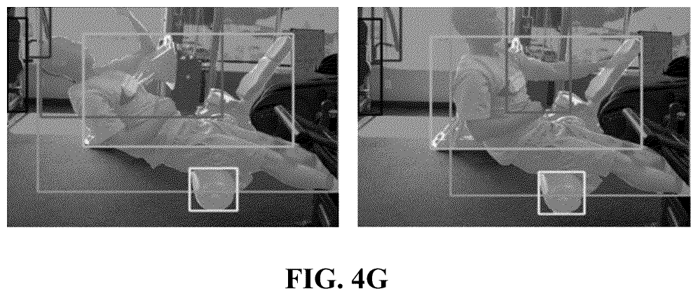

FIG. 4A-4G are schematic diagrams illustrating annotations of different granularities from multiple subsets in the training dataset according to some embodiments of the present disclosure. FIG. 4A illustrating an example 400 of unifying the various types of annotations and data used for training the object processing model. As shown in FIG. 4A, an image 402 shows a scene with multiple objects such as cars, motorcycles, persons, etc. the image 402 is a basis for all the annotations. A list of categories 404 lists the general categories of objects. The list of categories 404 corresponds to a dataset, therefore some categories in the list of categories 404 can be found in the image 402, and other categories in the list of categories 404 cannot be found in the image 402. FIG. 4B shows an example of an image with categories and bounding boxes. Arbitrary names 406 are specific names for objects that may not fall into standard categories. An object caption 408 is a description of specific objects. A referring expression 410 is a description to locate and identify specific objects within the image 402. FIG. 4C shows an example of an image with descriptions of objects and bounding boxes. Class-agnostic masks 412 may provide the shapes and locations of the objects in the image 402. FIG. 4D shows an example of an image with masks but without categories or expressions. Video data 414 comprises categories and expressions for dynamic scenes in video sequences. FIG. 4E shows an example of two video frames with bounding boxes, masks, and categories. FIG. 4F shows an example of two video frames with bounding boxes, masks, and expressions. FIG. 4G shows an example of two video frames with bounding boxes and masks but without categories or expressions.

In this way, the multiple types of data can be unified in a form as shown in FIG. 4A. By training the object processing data with the training dataset 300, the unified support for multi-source data greatly facilitates the incorporation of additional manually or automatically annotated data, enabling easy scaling of the dataset. Furthermore, the alignment of model optimization across tasks means that joint training serves not only as a unifying strategy but also as a mechanism to boost performance across individual tasks.

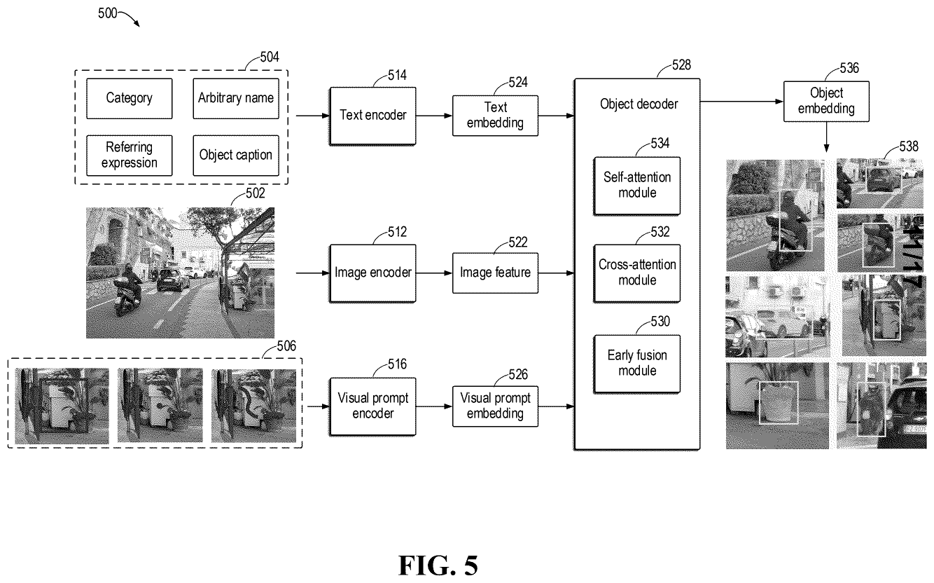

FIG. 5 is a schematic diagram illustrating an example framework 500 of the object processing model according to some embodiments of the present disclosure. As shown in FIG. 5, the framework 500 comprises an image encoder 512, a text encoder 514 and an object decoder 528. Given an input image 502 (denoted as I∈ [symbol] ), the image encoder 512 may extract a multi-scale image feature 522 (denoted as Z), from the image 502 with a backbone network (e.g., ResNet). The text encoder 514 may generate a text embedding 524 based on a text prompt 504. The text prompt 504 may be arbitrary descriptions related to the task, including object categories, arbitrary names, object captions, or referring expressions. The visual prompt encoder 516 may generate a visual prompt embedding 526 based on the visual prompt 506. The visual prompt 506 may be points, boxes, or scribbles provided through interactive segmentation.

In some embodiments, the model may generate a plurality of proposed object embeddings based on the image feature 522 and the prompt embedding (e.g., the text embedding 524 or the visual prompt embedding 526). Then the model may determine a similarity between the prompt embedding and each of the plurality of proposed object embeddings. Then the model may generate a target object embedding based on the similarity, and generate the object perception information based on the target object embedding. For example, the object decoder 528 may generate an object embedding 536 (denoted as q_{d}∈ [symbol] ) based on the image feature 522 and one of text embedding 524 and the visual prompt embedding 526. The object decoder 528 may comprise a dynamic class head for determining a similarity between the object embedding 536 and the text embedding 524 (or the visual prompt embedding 526).

The framework 500 may also comprise three prediction heads, i.e., a classification head, a detection head, and a segmentation head. The object embedding 536 may be fed into these three prediction heads to generate object perception information 538. The classification head may generate a category of the object corresponding to the object embedding 536. The detection head may generate a bounding box of the object corresponding to the object embedding 536. The segmentation head may generate a mask of the object corresponding to the object embedding 536.

In some embodiments, a ¼ resolution pixel embedding map

$${M}_{p} ∈ {ℛ}^{C \times \frac{H}{4} \times \frac{W}{4}}$$

may be obtained by up-sampling and fusing the image feature 522 and another multi-scale feature from a Transformer encoder. The binary mask prediction

$$m ∈ {ℛ}^{N \times \frac{H}{4} \times \frac{W}{4}}$$

may be obtained by performing a dot product between N mask embeddings and a pixel embedding map. As shown in Equation (1) at below:

$$m = FFN ( {q}_{d} ) ⊗ {M}_{p} \qquad ( 1 )$$

where FFN is a 3-layer feed forward head with ReLU activation function and a linear projection layer.

In some embodiments, one or more token embeddings may be generated by feeding a category name in the list of categories as a separate sentence into the text encoder. Then a category name embedding for the category name may be generated by determining an average of the one or more token embeddings. The prompt embedding may be generated based on the category name embedding. For example, the framework 500 may feed K category names as separate sentences into the text encoder 514 (denoted as Enc_{L}) and use the average of each sentence tokens as the output text embedding eₜ∈ [symbol] for each category or description. Then, alignment scores S_{align}∈ [symbol] between the object embedding and the text embedding may be determined by Equation (2) at below:

$${S}_{align} = {q}_{d} \cdot {W}_{i 2 t} ⊗ {e}_{t} \qquad ( 2 )$$

where Wᵢ₂ₜ∈ [symbol] denotes image-to-text projection weights.

The framework 500 may use logits S_{align} to replace traditional classification logits to determine Hungarian matching cost during the training stage and assign categories to the objects during the inference stage.

In some embodiments, an early fusion module 530 may be adopted to make the image feature 522 prompt-aware. The early fusion module 530 may perform bi-directional cross-attention on the image feature 522 and the prompt embedding (e.g., the text embedding 524 or the visual prompt embedding 526) to generate a fused image feature. The plurality of proposed object embeddings may be generated based on the fused image feature. In this way, the fused image feature can be more contextually relevant and aligned with the specific requirements provided by the prompts.

In some embodiments, the object decoder 528 may initialize a plurality of first object embeddings, and generate a plurality of second object embeddings by performing, by a cross-attention module 532, cross-attention on the plurality of first object embeddings and the fused image feature. Then the object decoder 528 may generate the plurality of proposed object embeddings by performing, by a self-attention module 534, self-attention on the plurality of second object embeddings and the prompt embedding. In some embodiments, the object decoder 528 may comprise multiple layers, where each layer comprises a cross-attention module 532, followed by a self-attention module 534. By performing cross-attention between the first object embeddings and the fused image feature, the object decoder can effectively integrate contextual information from the image, ensuring that the embeddings are relevant to the actual objects present in the image. By subsequently applying self-attention between the second object embeddings and the prompt embedding, the object embeddings can be refined based on the prompt information, ensuring that the generated embeddings can be aligned with the specific context provided by the prompts.

In this way, the object processing model can be used to seamlessly unify a broad range of object perception tasks in images and videos, including object detection, instance segmentation, grounding, multi-target tracking (MOT), video instance segmentation (VIS), video object segmentation (VOS), interactive segmentation and tracking. Furthermore, the object processing model can also support open-world/large-vocabulary image and video detection and segmentation tasks.

For detection task, a fixed-length list of categories is given and all objects in the list of categories are required to be detected. For a dataset with category list length K, the text input may be formulated as

$${\{ {p}_{k} \}}_{k = 1}^{K} ,$$

where pₖ represents for the k-th category name (e.g., P=[“person”, “bicycle”, “car”, . . . , “toothbrush”]). For datasets with large vocabulary, the calculation of the text embedding of all categories is time-consuming and redundant. Therefore, for datasets with a category number greater than a predefined threshold (e.g., 100), a list of positive categories in the image may be determined. Then a list of target categories may be generated based on the list of positive categories by randomly sampling from negative categories, where a size of the list of target categories equals to the predefined threshold. The list of target categories may be determined as the text prompt. For instance segmentation, the mask branch (e.g., the segmentation head) may be enabled, and a mask matching cost may be added with a mask loss.

In this way, the efficiency of the calculation of the text embedding can be improved. Furthermore, because the list of the target categories comprise both of the positive categories and the negative categories, the accuracy of the generated text embedding can be improved.

The grounding and referring segmentation tasks provide reference textual expressions, where objects are described with attributes. In some embodiments, one or more token embeddings may be generated by feeding the referring expression into the text encoder. The prompt embedding may be generated by applying global average pooling on the one or more token embeddings. For example, all the object expressions may be fed into the text encoder as text prompts. For each expression, a text embedding eₜ may be obtained by applying global average pooling along the sequence dimension. The text embeddings may be fed into the early fusion module and additionally interact with the object embeddings by the self-attention module in the object decoder. In this way, the integration of textual and visual information can be improved, and the contextual understanding can be improved.

Both multi-object tracking tasks and video instance segmentation tasks need to detect and track all the objects in a predefined category list. Furthermore, the video instance segmentation tasks require additional masks for the objects. These two tasks may be considered as extended tasks of detection and instance segmentation tasks on videos. With sufficient image exposure, the object embeddings generated by the object decoder can effectively differentiate objects in a video, demonstrating strong discriminability and temporal consistency. As a result, the object processing model can be directly employed for tracking without the need for an additional tracking head.

Training on image-level data can handle straightforward tracking scenarios. However, in situations involving severe occlusion, image-level training does not ensure that the model maintains strong temporal consistency. Thus, for occlusion scenarios, it is crucial to use video data for training. In some embodiments, a first frame of a video comprising an object may be obtained, and a second frame of the video comprising the object and a further object may be obtained. A first object embedding for the object in the first frame and a second object embedding for the object in the second frame may be generated. Furthermore, a third object embedding for the further object in the second frame may be generated. A contrastive tracking loss may be determined based on the first object embedding, the second object embedding and the third object embedding, and the object processing model may be trained based on the contrastive tracking loss. During inference stage, the detected objects may be tracked by bipartite matching of the corresponding object embeddings. In this way, the contrastive learning between frames can make the embedding of the same object closer in the embedding space, and the embedding of different object instances farther away.

Interactive segmentation tasks take various forms of visual prompts, such as points, boxes, or scribbles, to segment the specified objects within an image. Furthermore, video object segmentation tasks aim to segment the entire object throughout the entire video based on a mask provided in the first frame of the video. In some embodiments, a prompt square area in the image may be determined based on the visual prompt. The prompt embedding may be generated based on the prompt square area by using the image encoder. In some embodiments, a visual embedding in the prompt square area of the prompt embedding may be determined, and the object perception information of the object may be generated based on the image feature, the prompt embedding and the visual embedding.

For example, the visual prompt embeddings may be extract twice in the object processing model. First, the prompt square area from a RGB image may be cropped, and a visual prompt feature of the corresponding area may be generated by sending the prompt square area into the image encoder before the Transformer encoder. Second, a fine-grained visual prompt embedding may be sampled from the pixel embedding map Mₚ according to the visual prompt. Then the visual prompt embedding generated by the image encoder and the visual prompt embedding sampled from the pixel embedding map may be fed into the self-attention module in the object decoder to perform self-attention with the object embeddings, as the same with the text embeddings. In this way, the performance of the object decoder can be improved, and the accuracy of the object embeddings can be improved.

The object processing model may be trained jointly in an end-to-end manner on over 5 million images from diverse benchmarks with various levels of supervision. Different loss functions may be selected for training on various datasets. The object processing model may be trained based on a semantic loss, a box loss, a mask loss, a confidence loss, a contrastive tracking loss, and a distillation loss. For all tasks with a list of categories or object expression, a Focal loss may be applied as the semantic loss on the logits S_{align} to align the text concepts with the object features. For box prediction, a combination of L1 loss and generalized IoU loss may be applied. The mask loss may be defined as a combination of a Dice loss and a Focal loss. For the visual prompt segmentation tasks, an addition FFN may be employed to predict the confidence score for each object embeddings supervised by a Focal loss.

For video tasks, two frames of a video may be sampled, and a contrastive tracking loss [symbol] _{embed} on the object embedding from the last layer of the object embedding may be determined by Equation (3) at below:

$${ℒ}_{embed} = log [ 1 + {\sum }_{{k}^{+}} {\sum }_{{k}^{-}} exp ( v \cdot {k}^{-} - v \cdot {k}^{+} ) ] \qquad ( 3 )$$

where v is an object embedding for an object in a frame of a video, and k⁺ and k⁻ are the object embeddings belong to the same object and other objects from a reference frame.

For the text encoder, some existing models have achieved good performance on specific tasks. Therefore, a distillation training process may be applied for the text encoder. In some embodiments, a training sample is from a subset for a specific object perception task. A teacher encoder may be initialized with a pre-trained encoder for the specific object perception task. A teacher embedding may be generated by feeding the prompt into the teacher encoder. Furthermore, a distillation loss may be determined based on the teacher embedding and the prompt embedding generated by the text encoder. Then the object processing model may be trained based on the generated object perception information, the labeled object perception information and the distillation loss.

For example, CLIP has good performance on the image dataset with categories, when the text encoder is trained on an image dataset with expressions, a CLIP text encoder may be initialized as the teacher encoder, and the text encoder of the object processing model may be treated as a student encoder. During the training process, the teach encoder may be froze and only the student is trained. A L1 loss [symbol] ₜₑₓₜ between the text encoder of the object processing model and the CLIP text encoder may be applied as Equation (4) at below to minimize their distance:

$${ℒ}_{text} = \frac{1}{K} {\sum }_{i = 0}^{K} ‖ {Enc}_{L} ( ( {p}_{i} ) - {Enc}_{CLIP} ( {p}_{i} ) ‖ \qquad ( 4 )$$

where pᵢ is the i-th prompt, Enc_{CLIP} is the CLIP text encoder, ENC_{L} is the text encoder of the object processing model, and K is the number of prompts.

In this way, the knowledge of the teach encoder can be distilled. Therefore, the text embedding generated by the text encoder of the object processing model can be maintained in a pre-trained vision-language embedding space.

The object processing model is able to easily scale up the training data and achieve better generalization performance. With the unified training paradigm, the training data can be expanded at a low cost by incorporating a large amount of automatically labeled data from existing datasets (e.g., SA1B and GRIT). SA1B provides extensive and detailed mask annotations, enhancing the object perception capabilities of the model, while GRIT offers a broader collection of referring-expression-bounding-box pairs, improving the object identification abilities and understanding of descriptions.

In some embodiments, during the inference stage, a target image with a target object and a target prompt indicating the target object may be obtained, where the prompt is any one of a category, an arbitrary name, a referring expression, a caption, a box, a point or a scribble. A target object perception information of the target object may be generated based on the target image and the target prompt.

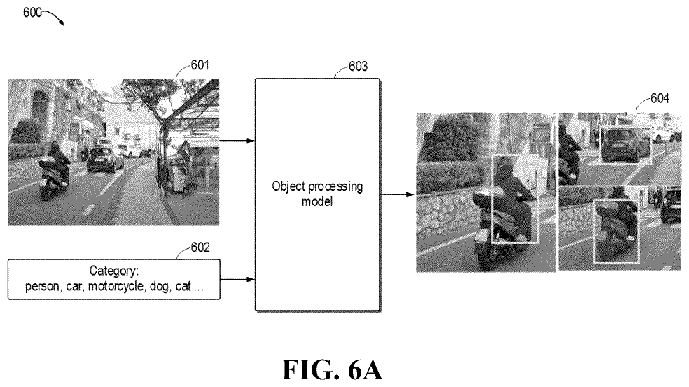

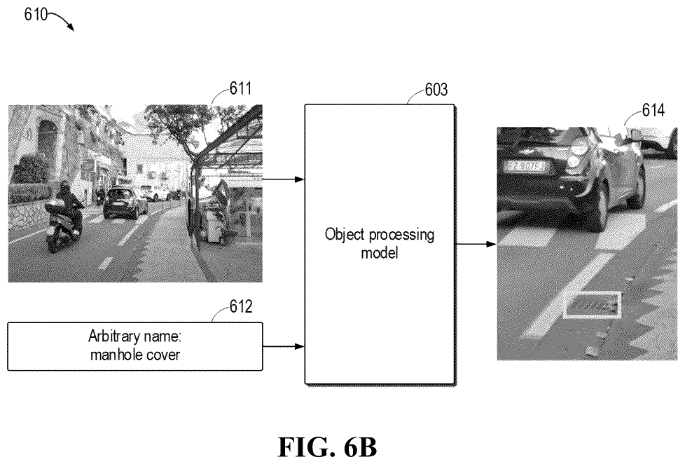

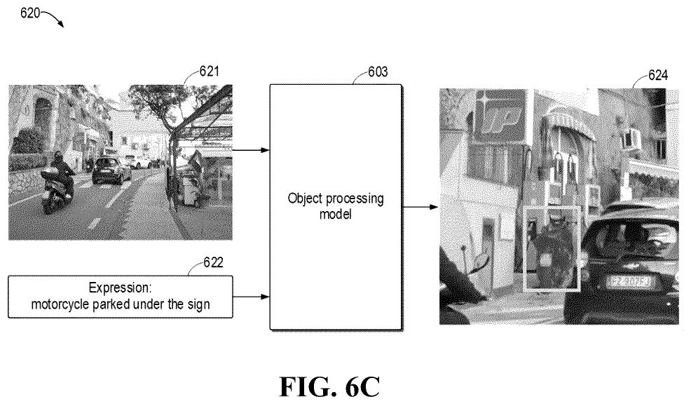

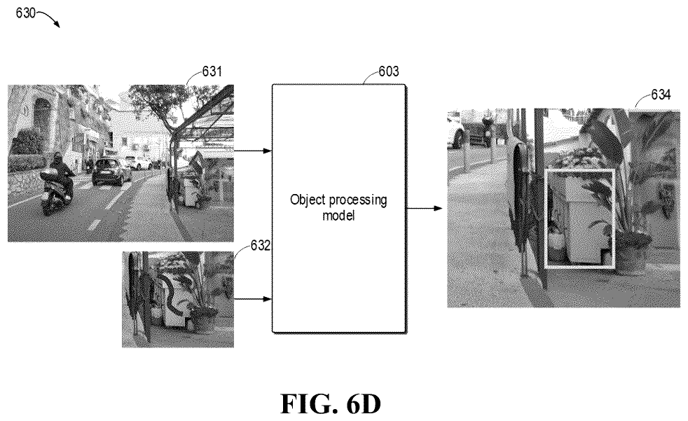

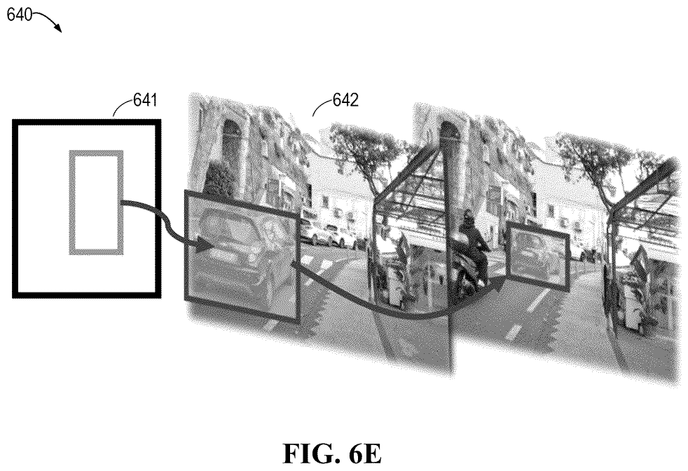

FIG. 6A-6E are schematic diagrams illustrating the execution of multiple object perception tasks using the trained object processing module during the inference stage according to some embodiments of the present disclosure. FIG. 6A shows an example 600 of inputting an image and a list of categories into a trained object processing model. As shown in FIG. 6A, an object processing model 603 is a trained model. An image 601 and a list of categories 602 are inputted into the object processing model 603. In an image 604 outputted by the object processing model 603, all the objects belonging to the list of categories are identified with bounding boxes and masks.

FIG. 6B shows an example 610 of inputting an image and an arbitrary name into a trained object processing model. As shown in FIG. 6B, an image 611 and an arbitrary name 612 (e.g., manhole cover) are inputted into the object processing model 603. In an image 614 outputted by the object processing model 603, the manhole cover is identified with a bounding box and a mask.

FIG. 6C shows an example 620 of inputting an image and an expression into a trained object processing model. As shown in FIG. 6C, an image 621 and an expression (e.g., motorcycle parked under the sign) are inputted into the object processing model 603. In an image 624 outputted by the object processing model 603, the motorcycle parked under the sign is identified with a bounding box and a mask.

FIG. 6D shows an example 630 of inputting an image and a visual prompt into a trained object processing model. As shown in FIG. 6D, an image 631 and a scribble 632 on a cabinet are inputted into the object processing model 603. In an image 634 outputted by the object processing model 603, the cabinet is identified with a bounding box and a mask.

FIG. 6E shows an example 640 of inputting a video and a visual prompt into a trained object processing model. As shown in FIG. 6E, a video and a box 641 indicating a car in the video are inputted into the object processing model. In each frame of a video 642 outputted by the object processing model, the car indicated by the box 641 is identified with a bounding box and a mask.

In some examples, to ensure the generalization of the object processing model as an object-level foundation model, joint training may be conducted by using a substantial amount of data with region-level annotations from both images and videos. Existing datasets exhibit variations in annotation granularity: detection datasets such as Objects365 and Open Images provide bounding boxes and category names; COCO and LVIS offer more detailed mask annotations; RefCOCO and Visual Genome include comprehensive object descriptions. Furthermore, video datasets contribute to the temporal consistency of models, and open-world data enrich the annotations with class-agnostic object information. Subsets of 500,000 and 2,000,000 images may be extracted from the SA1B dataset for joint training and scale-up training respectively. To ensure that objects from SA1B are at the object-level rather than the part-level, the mask IoU based NMS may be applied and the area as NMS score may be used to eliminate part-level object annotations. For GRIT data, 5,000,000 samples may be scaled for scale-up training to enhance the richness of object descriptions.

In some examples, following the image encoder, the text encoder, and the visual prompt encoder, a 6-layer deformable transformer encoder and a 9-layer decoder may be used to serve as the object decoder. 300 object embeddings, the query de-noising, and the hybrid matching may be used to accelerate convergence and improve performance.

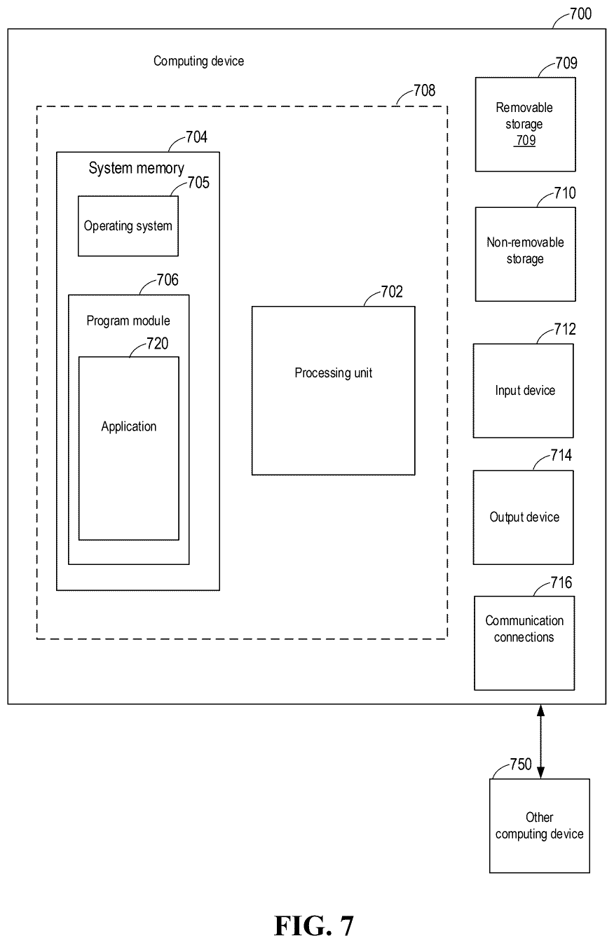

FIG. 7 is a block diagram illustrating physical components (e.g., hardware) of an electronic device 700 with which aspects of the disclosure may be practiced. For example, the electronic device 700 may implements the processes as depicted in FIGS. 1-6. In a basic configuration, the processing device 700 may include at least one processing unit 702 and a system memory 704. Depending on the configuration and type of computing device, the system memory 704 may comprise, but is not limited to, volatile storage (e.g., random access memory), non-volatile storage (e.g., read-only memory), flash memory, or any combination of such memories.

The system memory 704 may include an operating system 705 and one or more program modules 706 suitable for performing the various aspects disclosed herein such. The operating system 705, for example, may be suitable for controlling the operation of the processing device 700. Furthermore, aspects of the disclosure may be practiced in conjunction with other operating systems, or any other application program and is not limited to any particular application or system. This basic configuration is illustrated in FIG. 7 by those components within a dashed line 708. The processing device 700 may have additional features or functionality. For example, the processing device 700 may also include additional data storage devices (removable and/or non-removable) such as, for example, magnetic disks, optical disks, or tape. Such additional storage is illustrated in FIG. 7 by a removable storage device 709 and a non-removable storage device 710.

As stated above, several program modules and data files may be stored in the system memory 704. While executing on the at least one processing unit 702, an application 720 or program modules 706 may perform processes including, but not limited to, one or more aspects, as described herein. The application 720 may include an application interface 721 which may be the same as or similar to the application interface 721 as previously described in more detail with regard to FIGS. 1-6. Other program modules that may be used in accordance with aspects of the present disclosure may include electronic mail and contacts applications, word processing applications, spreadsheet applications, database applications, slide presentation applications, drawing or computer-aided application programs, etc., and/or one or more components supported by the systems described herein.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 7 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the processing device 500 on the single integrated circuit (chip). Aspects of the disclosure may also be practiced using other technologies capable of performing logical operations such as, for example, AND, OR, and NOT, including but not limited to mechanical, optical, fluidic, and quantum technologies. In addition, aspects of the disclosure may be practiced within a general-purpose computer or in any other circuits or systems.

The processing device 700 may also have one or more input device(s) 712 such as a keyboard, a mouse, a pen, a sound or voice input device, a touch or swipe input device, etc. The output device(s) 714 such as a display, speakers, a printer, etc. may also be included. The aforementioned devices are examples and others may be used. The processing device 500 may include one or more communication connections allowing communications with other computing or processing devices 750. Examples of suitable communication connections include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 904, the removable storage device 709, and the non-removable storage device 710 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the processing device 700. Any such computer storage media may be part of the processing device 700. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Any of the steps, functions, and operations discussed herein can be performed continuously and automatically.

The exemplary systems and methods of this disclosure have been described in relation to computing devices. However, to avoid unnecessarily obscuring the present disclosure, the preceding description omits several known structures and devices. This omission is not to be construed as a limitation. Specific details are set forth to provide an understanding of the present disclosure. It should, however, be appreciated that the present disclosure may be practiced in a variety of ways beyond the specific detail set forth herein.

Furthermore, while the exemplary aspects illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

While the flowcharts have been discussed and illustrated in relation to a particular sequence of events, it should be appreciated that changes, additions, and omissions to this sequence can occur without materially affecting the operation of the disclosed configurations and aspects.

Several variations and modifications of the disclosure can be used. It would be possible to provide for some features of the disclosure without providing others.

In yet another configurations, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another configuration, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another configuration, the disclosed methods may be partially implemented in software that can be stored on a non-transitory storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

The disclosure is not limited to standards and protocols if described. Other similar standards and protocols not mentioned herein are in existence and are included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various configurations and aspects, includes components, methods, processes, systems and/or apparatus substantially as depicted and described herein, including various combinations, sub-combinations, and subsets thereof. Those of skill in the art will understand how to make and use the systems and methods disclosed herein after understanding the present disclosure. The present disclosure, in various configurations and aspects, includes providing devices and processes in the absence of items not depicted and/or described herein or in various configurations or aspects hereof, including in the absence of such items as may have been used in previous devices or processes, e.g., for improving performance, achieving ease, and/or reducing cost of implementation.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

1. A method for training an object processing model, the object processing model comprising an image encoder, a text encoder, a visual prompt encoder and an object decoder, and the method comprising:
obtaining a training dataset comprising a plurality of subsets for a plurality of object perception tasks, wherein a sample in the training dataset comprises an image with an object, a prompt indicating the object, and labeled object perception information of the image;
generating, by the image encoder, an image feature based on the image;
generating, by the text encoder or the visual prompt encoder, a prompt embedding based on the prompt;
generating, by the object decoder, object perception information of the object based on the image feature and the prompt embedding; and
training the object processing model based on the generated object perception information and the labeled object perception information.

2. The method according to claim 1, wherein the plurality of subsets comprises:
a first subset providing a list of categories as text prompts;
a second subset providing arbitrary names as text prompts;
a third subset providing referring expressions as text prompts;
a fourth subset providing object captions as text prompts;
a fifth subset providing boxes as visual prompts;
a sixth subset providing points as visual prompts; and
a seventh subset providing scribbles as visual prompts.

3. The method according to claim 1, wherein generating, by the object decoder, the object perception information of the object based on the image feature and the prompt embedding comprises:
generating a plurality of proposed object embeddings based on the image feature and the prompt embedding;
determining a similarity between the prompt embedding and each of the plurality of proposed object embeddings;
generating a target object embedding based on the similarity; and
generating the object perception information based on the target object embedding.

4. The method according to claim 3, wherein the image is a first frame of a video from a subset for object tracking or video instance segmentation, the target object embedding is a first object embedding, and the method further comprises:
obtaining a second frame of the video comprising the object and a further object;
generating a second object embedding for the object in the second frame of the video;
generating a third object embedding for the further object in the second frame of the video; and
determining a contrastive tracking loss based on the first object embedding, the second object embedding and the third object embedding; and
training the object processing model based on the contrastive tracking loss.

5. The method according to claim 3, wherein generating the plurality of proposed object embeddings based on the image feature and the prompt embedding comprises:
generating a fused image feature by performing bi-directional cross-attention on the image feature and the prompt embedding; and
generating the plurality of proposed object embeddings based on the fused image feature.

6. The method according to claim 5, wherein generating the plurality of proposed object embeddings based on the fused image feature comprises:
initializing a plurality of first object embeddings;
generating a plurality of second object embeddings by performing cross-attention on the plurality of first object embeddings and the fused image feature; and
generating the plurality of proposed object embeddings by performing self-attention on the plurality of second object embeddings and the prompt embedding.

7. The method according to claim 1, wherein the prompt is a list of categories, and the method further comprises:
determining that a size of the list of categories is greater than a predefined threshold;
determining a list of positive categories in the image;
generating a list of target categories based on the list of positive categories by randomly sampling from negative categories, wherein a size of the list of target categories equals to the predefined threshold; and
determining the list of target categories as the prompt.

8. The method according to claim 1, wherein the prompt is a list of categories, and generating, by the text encoder or the visual prompt encoder, the prompt embedding based on the prompt comprises:
generating one or more token embeddings by feeding a category name in the list of categories as a separate sentence into the text encoder;
generating a category name embedding for the category name by determining an average of the one or more token embeddings; and
generating the prompt embedding based on the category name embedding.

9. The method according to claim 1, wherein the prompt is a referring expression, and generating, by the text encoder or the visual prompt encoder, the prompt embedding based on the prompt comprises:
generating one or more token embeddings by feeding the referring expression into the text encoder; and
generating the prompt embedding by applying global average pooling on the one or more token embeddings.

10. The method according to claim 1, wherein the prompt is a visual prompt, and generating, by the text encoder or the visual prompt encoder, the prompt embedding based on the prompt comprises:
determining a prompt square area in the image based on the visual prompt; and
generating, by the image encoder, the prompt embedding based on the prompt square area.

11. The method according to claim 10, wherein generating, by the object decoder, the object perception information of the object based on the image feature and the prompt embedding comprises:
determining a visual embedding in the prompt square area of the prompt embedding; and
generating the object perception information of the object based on the image feature, the prompt embedding and the visual embedding.

12. The method according to claim 1, wherein the prompt is a text prompt and the sample is from a subset for a specific object perception task, and training the object processing model based on the generated object perception information and the labeled object perception information comprises:
initialize a teacher encoder with a pre-trained encoder for the specific object perception task;
generating a teacher embedding by feeding the prompt into the teacher encoder;
determining a distillation loss based on the teacher embedding and the prompt embedding; and
training the object processing model based on the generated object perception information, the labeled object perception information and the distillation loss.

13. The method according to claim 1, wherein in an inference stage, the method further comprises:
obtaining a target image with a target object and a target prompt indicating the target object, wherein the prompt is any one of a category, an arbitrary name, a referring expression, a caption, a box, a point or a scribble; and
generating, by the object processing model, target object perception information of the target object based on the target image and the target prompt.

14. An electronic device, comprising:
a memory and a processor;
wherein the memory is configured to store one or more computer instructions which, when executed by the processor, cause the processor to:
obtain a training dataset comprising a plurality of subsets for a plurality of object perception tasks, wherein a sample in the training dataset comprises an image with an object, a prompt indicating the object, and labeled object perception information of the image;
generate, by the image encoder, an image feature based on the image;
generate, by the text encoder or the visual prompt encoder, a prompt embedding based on the prompt;
generate, by the object decoder, object perception information of the object based on the image feature and the prompt embedding; and
train the object processing model based on the generated object perception information and the labeled object perception information.

15. The device according to claim 14, wherein the plurality of subsets comprises:
a first subset providing a list of categories as text prompts;
a second subset providing arbitrary names as text prompts;
a third subset providing referring expressions as text prompts;
a fourth subset providing object captions as text prompts;
a fifth subset providing boxes as visual prompts;
a sixth subset providing points as visual prompts; and
a seventh subset providing scribbles as visual prompts.

16. The device according to claim 14, wherein the instructions causing the processor to generate, by the object decoder, the object perception information of the object based on the image feature and the prompt embedding comprises instructions causing the processor to:
generate a plurality of proposed object embeddings based on the image feature and the prompt embedding;
determine a similarity between the prompt embedding and each of the plurality of proposed object embeddings;
generate a target object embedding based on the similarity; and
generate the object perception information based on the target object embedding.

17. The device according to claim 16, wherein the image is a first frame of a video from a subset for object tracking or video instance segmentation, the target object embedding is a first object embedding, and the instructions further causes the processor to:
obtain a second frame of the video comprising the object and a further object;
generate a second object embedding for the object in the second frame of the video;
generate a third object embedding for the further object in the second frame of the video; and
determine a contrastive tracking loss based on the first object embedding, the second object embedding and the third object embedding; and
train the object processing model based on the contrastive tracking loss.

18. The device according to claim 16, wherein the instructions causing the processor to generate the plurality of proposed object embeddings based on the image feature and the prompt embedding comprises instructions causing the processor to:
generate a fused image feature by performing bi-directional cross-attention on the image feature and the prompt embedding; and
generate the plurality of proposed object embeddings based on the fused image feature.

19. The device according to claim 18, wherein the instructions causing the processor to generate the plurality of proposed object embeddings based on the fused image feature comprises instructions causing the processor to:
initialize a plurality of first object embeddings;
generate a plurality of second object embeddings by performing cross-attention on the plurality of first object embeddings and the fused image feature; and
generate the plurality of proposed object embeddings by performing self-attention on the plurality of second object embeddings and the prompt embedding.

20. A non-transitory computer-readable medium comprising instructions stored thereon which, when executed by a processor, cause the processor to:
obtain a training dataset comprising a plurality of subsets for a plurality of object perception tasks, wherein a sample in the training dataset comprises an image with an object, a prompt indicating the object, and labeled object perception information of the image;
generate, by the image encoder, an image feature based on the image;
generate, by the text encoder or the visual prompt encoder, a prompt embedding based on the prompt;
generate, by the object decoder, object perception information of the object based on the image feature and the prompt embedding; and
train the object processing model based on the generated object perception information and the labeled object perception information.
